(19) United States
(12) Patent Application Publication
(10) Pub. No.: US 2024/0046283 A1
(43) Pub. Date: Feb. 8, 2024

(54) METHODS AND IOT SYSTEMS FOR INDUSTRIAL GAS DEMAND REGULATION BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Xiaojun WEI, Chengdu (CN); Feng WANG, Chengdu (CN)

(73) Assignee: CHENGDU QINCHUAN IOT TECHNOLOGY CO., LTD., Chengdu (CN)

(21) Appl. No.: 18/484,425

(22) Filed: Oct. 10, 2023

(30) Foreign Application Priority Data
Aug. 14, 2023 (CN) 202311015895.1

(51) Int. Cl. G06Q 30/018; G06Q 30/0202; G06Q 50/06

(52) U.S. Cl. CPC G06Q 30/018; G06Q 30/0202; G06Q 50/06

(57) ABSTRACT

A method and an Internet of Things (IoT) system for an industrial gas demand regulation based on a smart gas. The method includes: obtaining gas data and a user feature of at least one industrial user, the gas data including gas operation data and gas demand data of the at least one industrial user; determining, based on the gas data, the user feature, and an external feature, an estimated usage distribution; sending the estimated usage distribution to a smart gas user platform to obtain feedback data from the at least one industrial user; determining, based on the feedback data and the estimated usage distribution, an updated usage distribution; and determining, based on the updated usage distribution, a gas regulation program, the gas regulation program including at least one of a gas transmission volume and a gas storage volume between a region where the at least one industrial user is located.

### CROSS-REFERENCE TO RELATED APPLICATION

This application claims priority of Chinese Patent Application No. 202311015895.1 filled on Aug. 14, 2023, the contents of each of which are entirely incorporated herein by reference.

### TECHNICAL FIELD

The present disclosure relates to the field of a gas demand regulation, and in particular relates to a method and Internet of Things system for an industrial gas demand regulation based on a smart gas.

### BACKGROUND

Currently, with continuous promotion and popularization of a gas use, a gas data center tends to receive a great amount of data on a gas demand (gas usage). A reliability of some gas demand data may be directly determined, while some gas demand data may not be intuitively obtained due to different user types. An ability to analyze the gas demand data in a timely manner greatly affects an arrangement of peak regulation and voltage regulation, as well as a probability of subsequent gas complaint incidents.

Therefore, an Internet of Things (IoT) system for an industrial gas demand regulation based on a smart gas needs to be provided to determine a demand authenticity of the gas demand, and then gas consumption information corresponding to different time periods in the future may be accurately predict, so as to improve an industrial gas demand regulation efficiency, and timely and sufficiently satisfy a user demand and improve a user satisfaction.

### SUMMARY

One more embodiments of the present disclosure provide a method for an industrial gas demand regulation based on a smart gas. The method may be executed based on a smart gas management platform of an Internet of things (IoT) system for an industrial gas demand regulation based on a smart gas, the method including: obtaining gas data and a user feature of at least one industrial user, the gas data including gas operation data and gas demand data of the at least one industrial user; determining, based on the gas data, the user feature, and an external feature, an estimated usage distribution; sending the estimated usage distribution to a smart gas user platform to obtain feedback data from the at least one industrial user; determining, based on the feedback data and the estimated usage distribution, an updated usage distribution; and determining, based on the updated usage distribution, a gas regulation program, the gas regulation program including at least one of a gas transmission volume and a gas storage volume between a region where the at least one industrial user is located.

One or more embodiments of the present disclosure provide an IoT system for an industrial gas demand regulation based on a smart gas. The system including a smart gas user platform, a smart gas service platform, a smart gas management platform, a smart gas sensor network platform and a smart gas object platform; the smart gas management platform includes a gas business management sub-platform, a non-gas business management sub-platform, and a smart gas data center; the smart gas sensor network platform is used to interact with the smart gas data center and the smart gas object platform; the smart gas object platform is used to obtain gas data; the smart gas management platform is used to: obtain the gas data and user characteristics of at least one industrial user, the gas data including gas operation data and gas demand data of the at least one industrial user; based on the gas data, the user characteristics and external characteristics, determining the estimated usage distribution; sending the estimated usage distribution to the smart gas user platform via the smart gas service platform to obtain the feedback data of the at least one industrial user; based on the feedback data and user characteristics and external characteristics, obtaining the feedback data; based on the feedback data and the estimated usage distribution, determining an updated usage distribution; based on the updated usage distribution, determining a gas regulation program, the gas regulation program comprising a gas delivery volume and/or a gas storage volume between regions where the at least one industrial user is located.

One or more embodiments of the present disclosure provide a computer-readable storage medium. When the computer reads the computer instructions in the storage medium, the computer may execute the industrial method for a gas demand regulation based on smart gas as described in the above embodiments.

### BRIEF DESCRIPTION OF THE DRAWINGS

The present disclosure is further illustrated by way of exemplary embodiments, which is described in detail by means of the accompanying drawings. These embodiments are not limiting, and in these embodiments, the same numbering indicates the same structure, wherein:

FIG. 1 is a platform structure diagram illustrating an Internet of Things (IoT) system for an industrial gas demand regulation based on a smart gas according to some embodiments of the present disclosure;

FIG. 2 is a flowchart illustrating an exemplary method for an industrial gas demand regulation based on a smart gas according to some embodiments of the present disclosure;

FIG. 3 is a schematic diagram illustrating an exemplary authenticity prediction model according to some embodiments of the present disclosure; and

FIG. 4 is a schematic diagram illustrating an exemplary process for determining a usage trend distribution according to some embodiments of the present disclosure.

### DETAILED DESCRIPTION

To further illustrate the technical solutions of the embodiments of the present disclosure, the accompanying drawings required for describing the embodiments are briefly introduced below. Obviously, the accompanying drawings in the following description are only some examples or embodiments of the present disclosure, and without creative labor, those skilled in the art may apply the present disclosure to other similar scenarios based on these drawings. Unless obviously obtained from the context or the context illustrates otherwise, the same numeral in the drawings refers to the same structure or operation.

Flowcharts are used in the present disclosure to illustrate operations performed by a system of the embodiments of the present disclosure. It would be appreciated that the preceding or following operations may not necessarily be performed in an exact sequence. Instead, the operations may be processed in reverse order or simultaneously. Also, other operations may be added to these processes, or an operation or some operations may be removed from these processes.

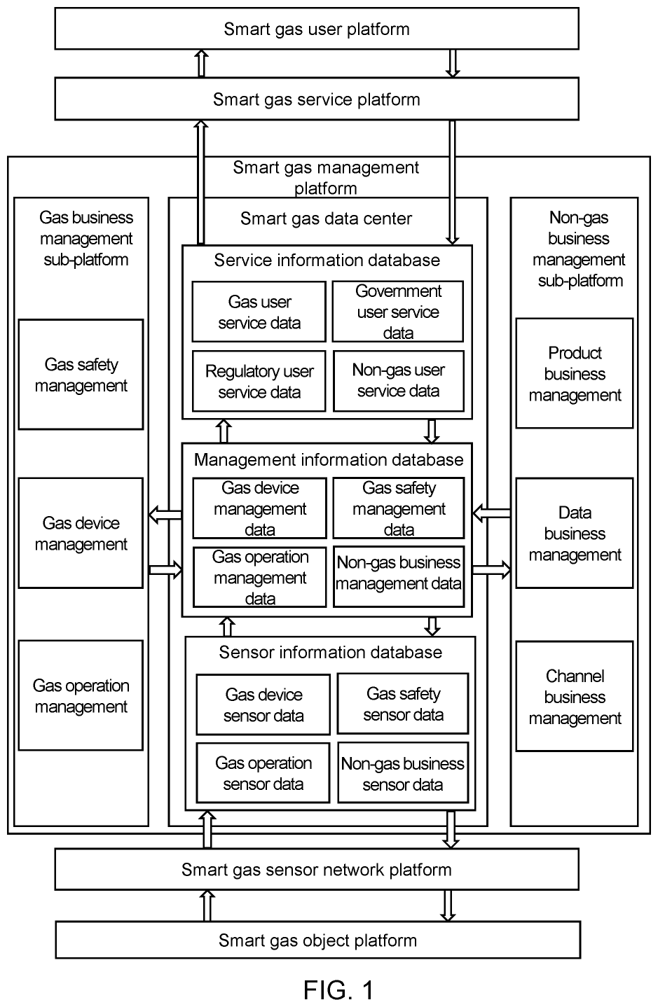

FIG. 1 is a platform structure diagram illustrating an Internet of Things (IoT) system for an industrial gas demand regulation based on a smart gas according to some embodiments of the present disclosure.

In some embodiments, the IoT system for an industrial gas demand regulation based on a smart gas may include a smart gas user platform, a smart gas service platform, a smart gas management platform, a smart gas sensor network platform, and a smart gas object platform.

The smart gas user platform may be a platform for interacting with a user. In some embodiments, the smart gas user platform may be configured as a terminal device.

The smart gas service platform may be a platform for receiving and transmitting data and/or information. For example, the smart gas service platform may transmit feedback data of the user to the smart gas management platform.

In some embodiments, the smart gas service platform may obtain an estimated usage distribution, an industrial gas regulation program, etc. from the smart gas management platform (e.g., a smart gas data center) and send the data to the smart gas user platform.

The smart gas management platform refers to a platform for overall planning and coordinating connections and cooperation among various functional platforms, gathering all information of the IoT system, and providing functions of perceptual management and control management for the IoT operation system.

In some embodiments, the smart gas management platform may include a gas business management sub-platform, a non-gas business management sub-platform, and the smart gas data center.

The gas business management sub-platform may be configured to manage a gas business. In some embodiments, the gas business management sub-platform may include, but not limited to, a gas safety management, a gas device management, and a gas operation management. The gas business management sub-platform may analyze and process information related to the gas business through aforementioned managements.

The non-gas business management sub-platform may be configured to manage a non-gas business. In some embodiments, the non-gas business management sub-platform may include but not limited to a product business management, a data business management, and a channel business management. In some embodiments, the non-gas business management sub-platform may analyze and process information related to the non-gas business.

The smart gas data center may be configured to store and manage all operational information based on the IoT system for an industrial gas demand regulation based on a smart gas. In some embodiments, the smart gas data center may be configured as a storage device for storing data related to a gas operation, such as a gas transmission volume and a gas storage volume, etc.

In some embodiments, the smart gas data center may include, but not limited to, a service information database, a management information database, and a sensor information database. In some embodiments, the service information database may include gas user service data, government user service data, regulatory user service data, and non-gas user service data. The management information database may include gas device management data, gas safety management data, gas operation management data, and non-gas business management data. The sensor information database may include gas device sensor data, gas safety sensor data, gas operation sensor data, and non-gas business sensor data.

In some embodiments, the smart gas data center may perform an information interaction with the gas business management sub-platform and the non-gas business management sub-platform.

In some embodiments, the smart gas management platform may perform the information interaction with the smart gas service platform and the smart gas sensor network platform through the smart gas data center. For example, the smart gas data center may send an industrial gas regulation program to the smart gas service platform.

For another example, the smart gas data center may send a gas data detection instruction to the smart gas sensor network platform and obtain historical use data of a gas transmitted by the smart gas sensor network platform.

The smart gas sensor network platform refers to a functional platform for managing a sensor communication.

In some embodiments, the smart gas sensor network platform may perform functions of a perceptual information sensor communication and a control information sensor communication.

In some embodiments, the smart gas sensor network platform may be configured to interact with the smart gas data center and the smart gas object platform, and to transmit historical use data of the gas.

The smart gas object platform refers to a functional platform for a perceptual information generation and a control information execution

In some embodiments, the smart gas object platform may be configured to obtain gas data. Further, the smart gas object platform may send the gas data to the smart gas data center of the smart gas management platform through the smart gas sensor network platform.

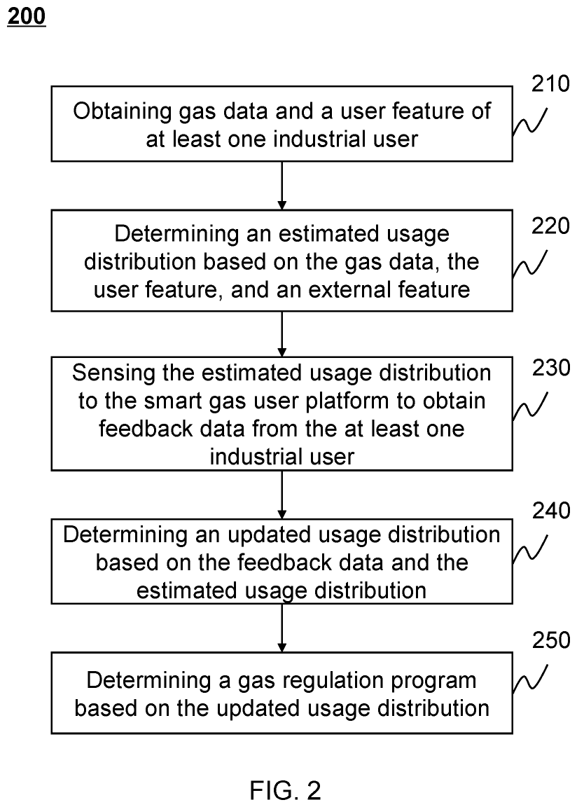

For more related contents of the above descriptions, please refer to the descriptions of FIGS. 2 to 4 as follows.

Based on the IoT system for an industrial gas demand regulation based on a smart gas, a closed loop of information operation may be formed between the smart gas object platform and the smart gas user platform, and a coordination and regular operation may be implemented under a unified management of the smart gas management platform to achieve informationization and intelligence of an industrial gas demand management.

FIG. 2 is a flowchart illustrating an exemplary method for an industrial gas demand regulation based on a smart gas according to some embodiments of the present disclosure. In some embodiments, a process 200 may be performed by a smart gas management platform.

As shown in FIG. 2, the process 200 may include the following operations.

In 210, gas data and a user feature of at least one industrial user may be obtained.

The gas data refers to data information related to a gas. In some embodiments, the gas data may include gas demand data of the at least one industrial user and gas operation data. The gas operation data may include monitoring data generated during a gas preparation, a gas transmission, and a gas use, and the gas demand data may include a use plan demand generated by the industrial user.

The use plan demand refers to the user's estimated plan for gas use. In some embodiments, the use plan demand may include an application estimated usage. The application estimated usage refers to an amount of gas demand applied by the industrial user based on an estimation.

In some embodiments, the smart gas management platform may obtain the gas data through a smart gas data center. The smart gas user platform may transmit the gas demand data input by the industrial user to a smart gas service platform, then the gas demand data may be transmitted to the smart gas data center.

The user feature refers to the data information related to the user. The user feature may include a user type, a user scale, and a gas use terminal of the user. The user scale refers to a scale of a gas use terminal, such as a number of the gas use terminal of the user. The gas use terminal of the user refers to a destination of the gas used by the user, such as a boiler, welding, smelting, etc.

In some embodiments, the smart gas management platform may obtain the user feature through the smart gas data center. The smart gas user platform may transmit the user feature input by the industrial user to the smart gas service platform, then the user feature may be transmitted to the smart gas data center.

In 220, an estimated usage distribution may be determined based on the gas data, the user feature, and an external feature.

The external feature refers to the data information of an external environmental factor related to the gas use. For example, the external feature may include a climate feature, a date feature, etc.

In some embodiments, the smart gas management platform may obtain the external feature based on a third-party platform. The third-party platform refers to an external platform that is capable of providing big data, such as a weather platform or a transportation center, etc.

The estimated usage distribution refers to a distribution situation of an estimated usage for a plurality of industrial users. For example, the estimated usage distribution may be expressed by a vector, a graph, or may be in other forms.

The estimated usage refers to an estimated actual gas usage of the industrial user. For more information on how to determine the estimated usage, please refer to the related descriptions below.

In some embodiments, the smart gas management platform may determine the estimated usage distribution in various ways. For example, for any of the at least one industrial user, the smart gas management platform may determine the estimated usage of the industrial user based on the gas data, the user feature, and the external feature through form checking, and then determine the estimated usage distribution based on the estimated usage. A preset relationship form may include correspondences between the gas data, the user feature, the external feature, and the estimated usage. For more information on determining the estimated usage distribution based on the estimated usage, please refer to the related descriptions below.

In some embodiments, for any of the at least one industrial user, the smart gas management platform may determine, based on the user feature, historical use data, the use plan demand, and the external feature, a demand authenticity of the industrial user. Further, the smart gas management platform may determine the estimated usage of the industrial user based on the use plan demand and the demand authenticity, and determine the estimated usage distribution based on the estimated usage corresponding to the at least one industrial user.

The demand authenticity refers to a degree to which the gas demand of the industrial user is authentic.

In some embodiments, the demand authenticity may be used to determine whether the demand of industrial users is real. For example, when the demand authenticity is low, it may indicate a situation of an inflated value or a misestimation by the industrial user on a gas usage in a future time period.

In some embodiments, the smart gas management platform may determine the demand authenticity in various ways. For example, the smart gas management platform may determine the demand authenticity through a similarity between historical demand data with the historical use data. The greater the similarity, the higher the demand authenticity.

In some embodiments, the smart gas management platform may determine at least one usage trend distribution based on the user feature of the at least one industrial user, at least one historical use data, and at least one use plan demand. Further, the smart gas management platform may determine the demand authenticity of the at least one industrial user based on the at least one usage trend distribution.

The historical use data refers to relevant data of a real gas use by the industrial user at a historical time, for example, the historical use data may include a historical gas usage, etc.

The usage trend refers to a trend of the gas usage by the industrial user. In some embodiments, the usage trend may be expressed by a number. For example, an increasing trend of the gas usage by the industrial user over a preset period of time (i.e., an increase in the usage trend) may be expressed by a positive value, while a decreasing trend (i.e., a decrease in the usage trend) may be expressed by a negative value.

In some embodiments, the smart gas management platform may determine the usage trend in various ways. For example, the smart gas management platform may determine the usage trend based on a variation of the gas usage through a preset calculation rule. The preset calculation rule may be a preset equation, a preset relationship form, etc.

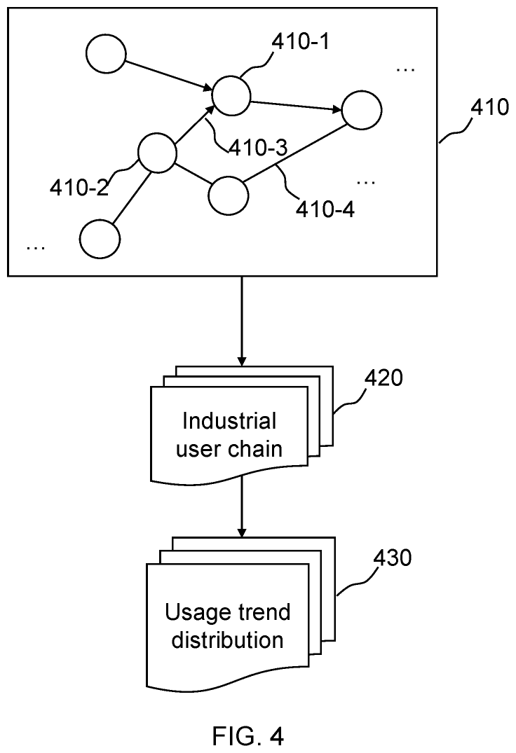

The usage trend distribution refers to the distribution situation of the usage trend for the at least one industrial user. In some embodiments, the at least one usage trend distribution may include the usage trend distribution for the same type of industrial users and the usage trend distribution for upstream and downstream industrial users. For more details about the same type of industrial users and the upstream and downstream industrial users, please refer to FIG. 4 and the related descriptions.

In some embodiments, the smart gas management platform may determine the at least one usage trend distribution through various modes. For example, the smart gas management platform may identify the same type of industrial users and the upstream and downstream industrial users of each industrial user based on the user feature of the industrial user; determine the usage trend of a single industrial user by determine the variation of the gas usage of the single industrial user based on the historical use data and the use plan demand; and determine the usage trend distribution by constructing an estimated usage trend vector based on the usage trend of each industrial user.

In some embodiments, the smart gas management platform may construct a user association mapping to determine an industrial user chain, and ultimately determine the usage trend distribution. For more details, please refer to FIG. 4 and the related descriptions.

In some embodiments, the smart gas management platform may determine the demand authenticity of the at least one industrial user based on the at least one usage trend distribution. For example, the smart gas management platform may calculate the usage trend of industrial user A's industrial user B of the same type, and the usage trend of industrial user A's upstream and downstream industrial user C. Based on the current use plan demand and the historical gas usage of industrial user A, the variation of gas usage of industrial user A may be calculated, and then the usage trend of industrial user A may be determined. A trend conformity degree between the usage trend of industrial user A and the usage trends of industrial users B and C may be calculated so as to increase or decrease the demand authenticity of industrial user A. The trend conformity degree may be calculated through the following equation (1):

W=|x−(k₁×x₁+k₂×x₂)|/(k₁×x₁+k₂×x₂) (1)

where, W, x, x₁ and x₂ respectively indicates the trend conformity degree, and the usage trends of industrial users A, B, and C. k₁ and k₂ respectively indicates weights of the usage trends of industrial users B and C, which are set by those skilled in the art empirically or by a system default.

In some embodiments, the trend conformity degree may be proportional to an increment of the demand authenticity. For example, if the trend conformity degree is less than a first preset threshold, the smaller the trend conformity degree, the greater the increment of the demand authenticity. For another example, if the trend conformity degree is greater than or equal to the first preset threshold, the greater the trend conformity degree, the greater a decrement of the demand authenticity. The first preset threshold may be set empirically or by system default.

In some embodiments, the usage trend distribution of the industrial user may be accurately determined by combining the user feature, the historical use data, and the use plan demand. According to the usage trend distribution, if the gas usage of a certain industrial user increases steeply, the demand authenticity may be lower. If a plurality of industrial users tend to increase their gas usage during the same time period, the demand authenticity of the industrial user may also increase accordingly, making the demand authenticity of the industrial user more accurate and reasonable.

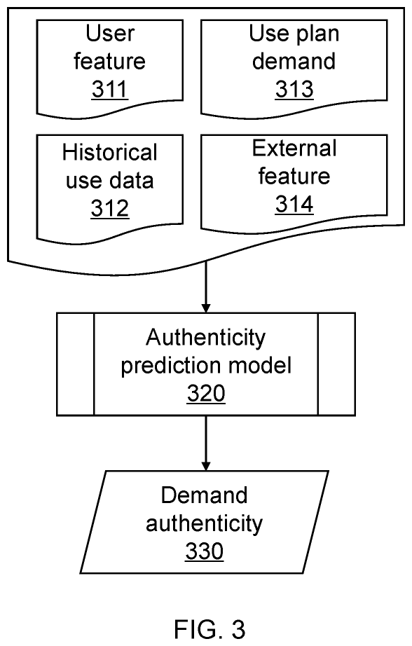

In some embodiments, the smart gas management platform may predict the demand authenticity by an authenticity prediction model based on the user feature, the historical use data, the use plan demand, and the external feature. For more information on this section, please refer to FIG. 3 and the related descriptions.

In some embodiments, the smart gas management platform may determine the estimated usage of any industrial user in various ways. For example, the smart gas management platform may determine the estimated usage for the industrial user based on the use plan demand and the demand authenticity through a vector matching.

In some embodiments, the smart gas management platform may determine the estimated usage of the industrial user according to a preset rule and based on the use plan demand and the demand authenticity of the industrial user.

The preset rule refers to a rule for determining the estimated usage. In some embodiments, the preset rule may be that in response to that the demand authenticity is greater than or equal to a second preset threshold, the application estimated usage in the use plan demand may be the estimated usage; and in response to that the demand authenticity is smaller than the second preset threshold, the estimated usage may be determined based on the historical gas usage in the historical use data. The second preset threshold may be set based on experience or by system default.

In some embodiments, when the demand authenticity is less than the second preset threshold and it is determined that there is a gap between the use plan demand and an actual situation, the estimated usage may be determined based on the historical gas usage in various ways. The gap may be that the application estimated usage sent by the industrial user exceeds a normal range of the gas usage of the industrial user due to a touch by mistake, etc. For example, the estimated usage may be determined using a Long Short-Term Memory (LSTM).

In some embodiments, by setting the preset rule, and determining a true or false situation of the use plan demand based on the demand authenticity, the estimated usage of the industrial user may be accurately determined, which helps to obtain reliable true gas demand data.

In some embodiments, the smart gas management platform may determine the estimated usage distribution based on the estimated usage corresponding to the at least one industrial user in various ways. For example, the smart gas management platform may construct an estimated usage vector based on the estimated usage of each industrial user, and determine the estimated usage vector as the estimated usage distribution.

In some embodiments, the estimated usage of the industrial user may be determined by the demand authenticity, so as to avoid an occurrence of irrational gas plan demand usage, and help to the improve the accuracy and authenticity of the estimated usage distribution.

In 230, the estimated usage distribution may be sent to the smart gas user platform to obtain feedback data from the at least one industrial user.

The feedback data refers to feedback information from the industrial user on a gas volume provided. For example, the feedback data may include an indication from the industrial user that a gas supply volume is appropriate, that the gas supply volume is low (by a certain volume), and that the gas supply volume is high (by a certain volume), etc.

In some embodiments, the smart gas management platform may obtain the feedback data directly through the smart gas data center. The smart gas user platform may transmit the feedback data input by the industrial user to the smart gas service platform, and the smart gas service platform may transmit the feedback data to the smart gas data center.

In 240, an updated usage distribution may be determined based on the feedback data and the estimated usage distribution.

The updated usage distribution refers to the distribution of an updated usage of the industrial user. Here, the update usage refers to an increased or decreased variation required based on the estimated gas usage.

In some embodiments, the smart gas management platform may determine the updated usage distribution by various modes based on the feedback data and the estimated usage distribution. For example, the smart gas management platform may modify the estimated usage distribution based on the feedback data and determine the updated usage distribution based on the modified estimated usage distribution. For another example, the smart gas management platform may calculate a difference value between the corresponding data in the feedback data and the corresponding data in the estimated usage distribution. If the difference value is less than a third preset threshold, the feedback data may be determined to be reasonable. Then, based on the feedback data, the industrial user data corresponding to the feedback data in the estimated usage distribution may be modified. If the difference value is greater than or equal to the third preset threshold, the feedback data may be determined to be unreasonable, and the data of the industrial user corresponding to the feedback data in the estimated usage distribution may not be modified. Ultimately, based on the latest estimated usage distribution, the updated usage distribution may be determined. The third preset threshold may be set empirically or by system default.

In 250, a gas regulation program may be determined based on the updated usage distribution.

The gas regulation program refers to a program that regulates the gas between different regions. In some embodiments, the gas regulation program may include a gas transmission volume and/or a gas storage volume between regions where the at least one industrial user is located. The gas transmission volume refers to a volume of gas delivered between the regions; and the gas storage volume refers to is a volume of gas stored in the regions.

In some embodiments, the smart gas management platform may determine the gas regulation program based on the updated usage distribution by a plurality of modes. For example, the smart gas management platform may determine the gas regulation program through the vector matching, the model identification, etc.

Through the obtaining of the gas data, the estimated usage distribution of the industrial user may be determined, and then combined with the user's feedback data, the estimated usage distribution may be reasonably adjusted in a timely manner, and the updated usage distribution may be determined, which in turn determines an accurate gas regulation program, which is conducive to a rational arrangement of a gas peak regulation and a pressure regulation, and reducing the occurrence of subsequent gas complaints.

In some embodiments, the smart gas management platform may determine a gas demand class based on the updated usage distribution; generate at least one candidate gas regulation program based on the gas demand class; evaluate regulation effectiveness degree of the at least one candidate gas regulation program; and determine the gas regulation program based on the regulation effectiveness degree.

The gas demand class refers to a class of regions belonging to a region where the industrial user is located based on the gas demand. In some embodiments, the gas demand class may include a gas high demand region, a gas medium demand region, and a gas low demand region, etc.

In some embodiments, the smart gas management platform may determine the gas demand class based on the updated usage distribution by various modes. For example, the smart gas management platform may determine the gas demand class through the vector matching, the model identification, etc.

In some embodiments, the smart gas management platform may determine a gas demand distribution based on the updated usage distribution and determine a gas demand class based on the gas demand distribution.

The gas demand distribution refers to the distribution of the gas demand in the region where the industrial user is located.

The gas demand refers to an estimated demand for gas usage after updating the usage for the industrial user.

In some embodiments, the smart gas management platform may determine a regulation region to which different industrial users belong based on a preset regulation form and the region where the industrial users are located. The regulation region refers to the region in which the gas regulation is required.

In some embodiments, the smart gas management platform may determine the gas demand of each industrial user based on the updated usage distribution and aggregate the gas demands of a plurality of industrial users in the same regulation region to calculate a total gas demand for each regulation region. The smart gas management platform may determine the gas demand distribution based on the total gas demand for each regulation region in various ways. For example, the smart gas management platform may determine the gas demand distribution by constructing a gas demand vector.

In some embodiments, the smart gas management platform may determine the gas demand class based on the gas demand distribution (e.g., the total gas demand for each regulation region) using a preset level form.

The preset level form may include different ranges of the total gas demand (e.g., incremental total gas demand ranges) and their corresponding gas demand classes for the regulation region. The preset level form may be constructed based on the historical experience.

In some embodiments, by determining the gas demand distribution in the region where the industrial user is located by the updated usage distribution, and then accurately classifying the gas demand class based on the gas demand distribution, a reasonable determination of a subsequent gas regulation program may be facilitated.

The candidate gas regulation program refers to a candidate program used to determine the gas regulation program.

In some embodiments, the smart gas management platform may generate at least one candidate gas regulation program based on the gas demand class in various ways. For example, the smart gas management platform may determine at least one candidate gas regulation sub-program corresponding to each regulation region through a preset program form. Furthermore, based on the candidate gas regulation sub-program, at least one candidate gas regulation program may be generated through a random combination.

In some embodiments, the candidate gas regulation sub-program may include information such as a pipeline for the gas regulation and a regulated gas volume, etc. The preset program form may include the gas demand classes corresponding to different regulation regions and at least one candidate gas regulation sub-program. The preset program form may be constructed based on the historical experience.

The regulation effectiveness degree refers to the degree of effectiveness of a gas regulation program in solving gas usage problems.

In some embodiments, the smart gas management platform may evaluate the regulation effectiveness degree of at least one candidate gas regulation program through a plurality of modes. For example, the smart gas management platform may determine the corresponding regulation effectiveness degree of the candidate gas regulation program through the vector matching.

In some embodiments, the smart gas management platform may assess the regulation effectiveness degree of the at least one candidate gas regulation program based on a preset strategy.

The preset strategy refers to the rules that determine the regulation effectiveness degree. In some embodiments, the preset strategy may be related to a relationship between a total dispatch volume and a current pipeline supply volume, a change in a pipeline pressure, and a dispatch efficiency.

The total dispatch volume refers to a total amount of gas that needs to be dispatched for the current pipeline. In some embodiments, the smart gas management platform may determine the pipeline for the gas regulation and the regulated gas volume for each regulated gas in each regulation gas region based on the candidate gas regulation program. The pipeline for the gas regulation may include a pipeline for supplying the dispatched gas and a pipeline for receiving the scheduled gas. In some embodiments, the pipeline for supplying the dispatched gas may have a negative total dispatch volume, and the pipeline for receiving the dispatched gas may have a positive total dispatch volume.

In some embodiments, the smart gas management platform may determine the pipeline for the gas regulation based on the candidate gas regulation program and calculate the total dispatch volume of the pipeline for the gas regulation.

The current pipeline supply volume refers to the maximum amount of the gas that the current pipeline supplies.

In some embodiments, the smart gas management platform may determine a first component of regulation effectiveness degree based on a relationship between the total dispatch volume and the current pipeline supply volume, a second component of regulation effectiveness degree based on the change in the pipeline pressure, and a third component of regulation effectiveness degree based on the dispatch efficiency. The first component of regulation effectiveness degree, the second component of regulation effectiveness degree, and the third component of regulation effectiveness degree may be components used to determine the regulation effectiveness degree.

In some embodiments, the relationship between the total dispatch volume and the current pipeline supply volume may be determined by a sum result. When the sum result is greater than or equal to 0, the first component of regulation effectiveness degree may be determined to be 1. When the sum result is less than 0, the first component of regulation effectiveness degree may be determined to be 0.

The change in the pipeline pressure situation refers to the change in the pipeline pressure that occurs before and after implementing the candidate gas regulation program. For example, the change in the pipeline pressure situation may be calculated as a difference between the pipeline pressure before and after gas dispatching. The pipeline pressure after gas dispatching may be calculated based on a physical principle.

In some embodiments, the smart gas management platform may determine the second component of regulation effectiveness degree based on the change in the pipeline pressure using the following equation (2):

q₂=|p₂−p₁|/p (2)

where q₂, p₁, p₂, and p, indicates the second component of regulation effectiveness degree, the pipeline pressure before gas dispatch, the pipeline pressure after gas dispatch, and the maximum pressure change that the pipeline may withstand, respectively.

The dispatch efficiency refers to an efficiency of the candidate gas regulation programs with different numbers of dispatch pipelines. In some embodiments, the smart gas management platform may determine an actual dispatch pipeline number based on the candidate gas regulation sub-program, and determine the dispatch efficiency of the candidate gas regulation sub-program using an equation (3). The smart gas management platform may further calculate an average of the dispatch efficiencies of all the candidate gas regulation sub-programs as the dispatch efficiency of the candidate gas regulation program. Equation (3) is as follows:

R=r×|g₁−g₂|/g₂ (3)

where, R, r, g₁, and g₂ respectively indicates the dispatch efficiency, a standard dispatch efficiency, the actual dispatch pipeline number, and a standard dispatch pipeline number of the candidate gas regulation sub-program. The standard dispatch efficiency and the standard dispatch pipeline number may be set by those skilled in the art based on the experience or by the system default.

In some embodiments, the smart gas management platform may determine a ratio of the dispatch efficiency of the candidate gas regulation program to the standard dispatch efficiency as the third component of regulation effectiveness degree.

In some embodiments, the smart gas management platform may determine the regulation effectiveness degree of a single pipeline by performing a weighted sum of the first component of regulation effectiveness degree, the second component of regulation effectiveness degree, and the third component of regulation effectiveness degree. Furthermore, the smart gas management platform may determine the regulation effectiveness degree of the candidate gas regulation program by performing a sum of the scheduling effective degrees of all pipelines.

In some embodiments, the weights of the first component of regulation effectiveness degree, the second component of regulation effectiveness degree, and the third components of regulation effectiveness degree may be correlated to the usage trend distribution and the demand authenticity.

In some embodiments, the weights of the first component of regulation effectiveness degree, the second component of regulation effectiveness degree, and the third component of regulation effectiveness degree may be determined by following equation (4), equation (5), and equation (6), respectively:

h₁=1−h₂−h₃ (4)

h₂=i₁×J/g₁ (5)

h₃=i₂×J/F (6)

where, h₁, h₂, and h₃ respectively indicates the weight of the first component of regulation effectiveness degree, the weight of the second component of regulation effectiveness degree and the weight of the third component of regulation effectiveness degree, and i₁ and i₂ indicate order of magnitude modulation parameters that correct h₂ and h₃ to values between 0 and 1. J and F respectively indicates the increase in usage trend and the updated usage of the industrial user. The increase in usage trend and the updated usage of the industrial user may be inversely proportional to the demand authenticity.

In some embodiments, determining the weights of the components of the regulation effectiveness degree through the usage trend distribution and the demand authenticity, a more accurate determination of the regulation effectiveness degree for the single pipeline may be achieved.

In some embodiments, the regulation effectiveness degree of the candidate gas regulation program may be evaluated based on a preset strategy that considers the relationship between the total dispatch volume and the current pipeline supply volume, the change in the pipeline pressure, and the dispatch efficiency. In this way, the reliability of the regulation effectiveness degree may be enhanced, and an accurate selection of a final gas regulation program may be achieved.

In some embodiments, the smart gas management platform may determine the gas regulation program by various means based on the regulation effectiveness degree. For example, the gas regulation program with the highest regulation effectiveness degree may be selected from the candidate gas regulation program.

The candidate gas regulation program may be generated based on the gas demand class of each region, and the regulation effectiveness degree may be assessed, so as to select the most efficient and reasonable gas regulation program.

FIG. 3 is a schematic diagram illustrating an exemplary authenticity prediction model according to some embodiments of the present disclosure.

In some embodiments, as shown in the FIG. 3, a smart gas management platform may predict, based on a user feature 311, historical use data 312, a use plan demand 313, and an external feature 314 of an industrial user, a demand authenticity 330 of the industrial user by an authenticity prediction model 320.

The authenticity prediction model refers to a model used to determine the demand authenticity of the industrial user. The authenticity prediction model may be a machine learning model, such as Neural Networks (NN), etc.

In some embodiments, an input to the authenticity prediction model 320 may include the user feature 311, the historical use data 312, the use plan demand 313, and the external feature 314, and an output may be the demand authenticity 330 of the industrial user.

In some embodiments, the first training sample of the authenticity prediction model may include a historical user feature, the historical use data, a historical use plan demand, and a historical external feature in historical data. A label of a first training sample may be a historical demand authenticity, and the label of the first training sample may be determined based on a ratio of (an industrial user application estimated usage-an actual gas usage) to the actual gas usage.

In some embodiments, the input to the authenticity prediction model 320 may also include a usage trend distribution and a user number corresponding to at least one industrial user chain.

The industrial user chain refers to a chain of users to which the industrial user belongs. In some embodiments, the industrial user chain may consist of a plurality of industrial users. For more details regarding the usage trend distribution and the user number corresponding to the at least one industrial user chain, please refer to FIG. 4 and the related descriptions.

In some embodiments, when the input to the authenticity prediction model includes the usage trend distribution and the user number corresponding to the at least one industrial user chain, the first training sample may also include the usage trend distribution and the user number corresponding to a sample industrial user chain.

In some embodiments, the usage trend distribution and the user number corresponding to the industrial user chain may be used as the input to the model. Fully considering an impact of an overall environment on the gas demand, in an event of emergencies, a pattern combining the overall environment may be more effective than relying solely on a user gas pattern, so as to enhance an accuracy in reflecting the demand authenticity of the industrial user.

By combining the user feature, the historical use data, and the external feature through the authenticity prediction model, and utilizing a powerful capability of machine learning, the prediction accuracy of the demand authenticity may be effectively improved.

In some embodiments, the authenticity prediction model may include a plurality of authenticity prediction sub-models. The smart gas management platform may predict a sub-demand authenticity of the industrial user by the authenticity prediction sub-model based on the user feature, the historical use data, the use plan demand, and the external feature; and determine, based on a plurality of sub-demand authenticities, the demand authenticity by weighting.

The authenticity prediction sub-model refers to a model used to determine the sub-demand authenticity for the industrial user. For example, the authenticity prediction sub-model may be a machine learning model.

In some embodiments, an input to the authenticity prediction sub-model may include the user feature, the historical use data, the use plan demand, and the external feature, and an output may be the sub-demand authenticity for the industrial user.

The sub-demand authenticity refers to the different demand authenticities of a plurality of industrial users determined based on different data.

In some embodiments, a plurality of sampling training datasets may be determined based on an original training dataset including the first training sample. One sampling training dataset may serve as a second training sample and a label for the authenticity prediction sub-model.

In some embodiments, the smart gas management platform may determine a plurality of sampling training datasets based on the original training dataset through the following operations.

Operation 1, randomly sampling a preset range of quantity of original training data from the original training dataset to create a dataset to be determined.

The dataset to be determined refers to the dataset waiting to be determined whether it may be used as the sampling training dataset. The preset range of quantity may be set based on experience or set by system default.

By forming a dataset to be determined by random sampling, and then determining the sampling training dataset, a data complexity of the dataset may be reduced to a certain extent and effectively prevent the authenticity prediction sub-model from having insufficient learning ability, and being unable to learn the “general pattern” in the complex data, and resulting in a weak generalization ability.

Operation 2, calculating a distribution of the gas user for the dataset to be determined.

In some embodiments, for each training data (i.e., the first training sample) in the dataset to be determined, a sample gas user feature and sample gas historical use data may be spliced into a sample vector. Based on the sample vector corresponding to each training data, a clustering may be performed to obtain a clustering result. Based on the clustering result, the distribution of the gas user may be obtained.

In some embodiments, a clustering algorithm may be the clustering algorithm that does not require a pre-specified number of clusters, such as a density-based clustering algorithm with a noise. The clustering result may include the cluster center of each cluster and a number of sample vectors in each cluster. The gas user distribution refers to a ratio of the number of sample vectors in each cluster. For example, if the clustering result is 3 clusters and the number of sample vectors in clusters 1, 2, and 3 is a, b, and c respectively, the gas user distribution may be expressed as a:b:c.

Operation 3, determining a preset similarity threshold based on the gas user distribution of the dataset to be determined.

In some embodiments, by a preset relationship, the preset similarity threshold may be determined based on the gas user distribution of the dataset. The preset relationship may be that the smaller a variance of the gas user distribution (i.e., the more homogeneous the number of sample vectors in the cluster), the smaller the preset similarity threshold. Setting the preset similarity threshold allows for a more even distribution of data in the sampled training dataset, thereby preventing an overfitting.

Operation 4: calculating the gas user distribution for the original training dataset.

In some embodiments, the calculating the gas user distribution for the original training dataset may be performed in the same way as calculating the gas user distribution for the dataset to be determined in operation one.

Operation 5: calculating a difference between the gas user distribution of the dataset to be determined and the gas user distribution of the original training dataset. Determining whether the dataset to be determined is the sampling training dataset based on the preset similarity threshold.

In some embodiments, the smart gas management platform may calculate an average value, a number of list elements, a median, and a variance difference between the gas user distribution of the dataset to be determined and the gas user distribution of the original training dataset, and then average these differences. Furthermore, the averaged value may be regarded as the difference between the gas user distribution of the dataset to be determined and the gas user distribution of the original training dataset.

In some embodiments, if the difference between the gas user distribution of the dataset to be determined and the gas user distribution of the original training dataset is less than or equal to the preset similarity threshold, the dataset to be determined may be considered as the sampling training dataset. In some embodiments, if the difference between the gas user distribution of the dataset to be determined and the gas user distribution of the original training dataset is greater than the preset similarity threshold, the dataset to be determined may be discarded to prevent a significant difference in data distribution between the sampled training dataset and the original training dataset.

Operation 6: repeating operations three to five to determine a preset number of sampling training datasets.

In some embodiments, if the preset number is the same as the number of the authenticity prediction sub-models, the sampling training datasets of the preset number may be used as the second training samples and the labels of the plurality of authenticity prediction sub-models, respectively. The preset number may be set according to actual needs.

In some embodiments, the smart gas management platform may determine the demand authenticity by weighting a plurality of sub-demand authenticities. The weighting of the sub-demand authenticity may be related to a demand fluctuation and a distance of the sub-demand authenticity from an average of the plurality of sub-demand authenticities. For example, if the number of the sub-demand authenticities is three, the equation for determining the demand authenticity may be as a following equation (7), and the weights of the sub-demand authenticities may be determined based on a following equation (8):

$$M = {n}_{1} \times {m}_{1} + {n}_{2} \times {m}_{2} + {n}_{3} \times {m}_{3} \qquad ( 7 )$$

$${n}_{1} = n / \vert \frac{{m}_{1} + {m}_{2} + {m}_{3}}{3} - {m}_{1} \vert \qquad ( 8 )$$

where, m₁, m₂, and m₃ respectively indicates the three sub-demand authenticities output by the three authenticity prediction sub-models, n₁, n₂ and n₃ respectively indicates the weights of the three sub-demand authenticities, M indicates the demand authenticity, n indicates a coefficient determined by the demand fluctuation, the greater the demand fluctuation, the greater the value of n.

$$\vert \frac{{m}_{1} + {m}_{2} + {m}_{3}}{3} - {m}_{1} \vert$$

indicates the distance between the sub-demand authenticity m₁ and the average

$$\frac{{m}_{1} + {m}_{2} + {m}_{3}}{3}$$

of the plurality of sub-demand authenticities. n₂ and n₃ may be calculated in the same way as n₁, which is not repeated here.

By using the plurality of authenticity prediction sub-models to predict a plurality of sub-demand authenticities, the overfitting of the predicted demand authenticity caused by a single authenticity prediction model may be effectively prevented. An accuracy of the demand authenticity determination may be improved through the weighted calculations. The weight may be correlated with the distance from the mean, allowing prediction results deviating from the mean to have smaller weights. The weight may also be correlated with the demand fluctuation, resulting in a smaller weight magnitude affected by the distance from the mean when the demand fluctuation is greater, thereby enhancing the accuracy of an overall demand authenticity prediction.

FIG. 4 is an exemplary schematic diagram illustrating a determination of the usage trend distribution according to some embodiments of the present disclosure.

In some embodiments, as shown in FIG. 4, a user association mapping 410 may be constructed, at least one industrial user chain 420 may be determined based on the user association mapping, and at least one usage trend distribution 430 may be determined based on the at least one industrial user chain.

In some embodiments, a smart gas management platform may construct the user association mapping based on a user feature of at least one industrial user, at least one historical use data, and at least one use plan demand.

For related contents on the user feature, the historical use data, and the use plan demand of the industrial user, please refer to FIG. 2 and the associated descriptions.

The user association mapping refers to a mapping that represents relationships between the industrial users. In some embodiments, the user association mapping 410 may be a data structure consisting of nodes, edges, or paths, which includes a plurality of nodes and a plurality of edges or paths connecting these nodes.

Each node corresponds to an industrial user. For example, a node 410-1 may correspond to a specific industrial user.

In some embodiments, a node feature of the user association mapping may include the user feature and a usage trend. The usage trend may be determined based on the historical use data and the use plan demand.

More information about the user feature and the usage trend may be found in FIG. 2 and the associated descriptions.

In some embodiments, an expression of the usage trend may be in a form of a percentage. For example, +20% indicates a 20% increase and −10% indicates a 10% decrease.

The edge may correspond to a relationship between the industrial users.

In some embodiments, the edge of the user association mapping may include two types of edges, a “same type of industrial user” edge, which refers to an undirected edge that exists between industrial users of the same type, e.g., a “same type of industrial user” edge 410-4; and an “upstream and downstream industrial user” edge, which refers to a directed edge that points from an upstream industrial user to a downstream industrial user, e.g., an “upstream and downstream industrial user” edge 410-3.

The same type of industrial user refers to the industrial user with a similarity greater than a fourth preset threshold. In some embodiments, the similarity may be determined based on a type, a direction of operation, a size, etc. of a company, and the fourth preset threshold may be set empirically or by the system default.

In some embodiments, the upstream and downstream of the industrial user may be determined based on upstream and downstream segments in an operation type corresponding to the user. For example, if the operation type of the industrial user is food and beverage, the upstream may be food development, production, or logistics and distribution, etc., and the downstream may be a processor or supplier of finished goods, etc. The operation type of the industrial user may be determined based on common sense, or may be obtained from registered business information. For example, the directed edge 410-3 may indicate that the industrial user corresponding to node 410-2 is the upstream industrial user and the industrial user corresponding to node 410-1 is the downstream industrial user. A pointing direction of an arrow of the directed edge 410-3 may indicate that the upstream industrial user points to the downstream industrial user.

In some embodiments, an edge feature of the user association mapping may include a gas association value. The gas association value refers to a similarity in a usage trend between two nodes (two industrial users), which indicates a degree of correlation between the two nodes.

In some embodiments, the usage trend of the industrial user in a historical usage time period may be calculated, and based on a usage trend interval division, a number of the usage trend in each interval may be calculated and expressed as a vector. The vector may be taken as a usage trend feature vector of the industrial user. The gas association value may be obtained by calculating the similarity of the usage trend feature vectors of two industrial users.

In some embodiments, a length of a historical use time period may be determined based on an actual accuracy and a processor performance. In some embodiments, at least one time period may be selected from the historical use time period.

In some embodiments, the usage trend interval division may be pre-determined based on the usage trend of the at least one industrial user. For example, in the usage trend of the at least one industrial user, with a maximum usage trend of 18% and a minimum of −14%, the usage trend interval division may be (−15%, −10%], (−10%, −5%], (−5%, 0%], (0%, +5%], (5%, 10%], (10%, 15%], (15%, 20%]. If an industrial user has a usage trend of +20%, +13%, −10%, +10%, −3%, and 14% in the historical usage time period, where there is 1 usage trend in the interval (−15%, −10%] and 0 usage trend in the interval (−10%, −5%], following the same process, a number of usage trends of the industrial user in each interval may be obtained, and then the usage trend feature vector of the industrial user as (1,0,0,1,1,2,1) may be obtained.

In some embodiments, a mode for calculating the vector similarity may include, but not limited to, a cosine similarity, a Euclidean distance, a Manhattan distance, etc.

In some embodiments, the edge may be preset and updated periodically. This is due to a fact that the industrial user in a marketplace may change, such as a change in the operation type of the industrial user. Another example may be a change in the upstream and downstream relationships of the operation type. In some embodiments, an update period may be preset.

In some embodiments, the user feature of the industrial user may be obtained by a smart gas data center, the historical use data of the industrial user may be obtained by a smart gas object platform, and the use plan demand of the industrial user may be obtained by a smart gas user platform. The smart gas management platform may construct the user association mapping based on the user feature, the historical use data, and the use plan demand of the at least one industrial user, as described above.

In some embodiments, in the user association mapping, the industrial users with related relationships may form one industrial user chain by connecting the industrial users with the edges. For example, certain industrial users may form one industrial user chain because they are connected by the edges due to the same type. Similarly, certain industrial users may form one industrial user chain because they are all in a certain supply chain (upstream and downstream) and have directed edges between them.

In some embodiments, there may be more than one industrial user chain determined based on the user association mapping.

In some embodiments, to determine at least one industrial user chain in which the industrial user is located, the node with an edge relationship with the node corresponding to the industrial user may be determined based on the user association mapping and the gas association value, the nodes and edges that satisfy the condition may be recorded, thereby determining the at least one industrial user chain. The condition may include identical types or an existence of upstream-downstream relationships.

In some embodiments, after determining the at least one industrial user chain, the smart gas management platform may determine the user number based on the number of nodes on the industrial user chain. The smart gas management platform may determine the usage trend distribution by analyzing the node feature and the edge feature of the industrial user chain.

In some embodiments, after obtaining the at least one industrial user chain in which the industrial user is located, a change rate for each user passed from the upstream may be calculated based on the gas association value, and an application change rate may be determined based on a plurality of change rates.

The change rate refers to a historical change in the gas usage for the industrial user.

In some embodiments, if the industrial user has at least two historical gas usages, the change rate for the industrial user may be calculated as follows: change rate=(current historical gas usage−last historical gas usage)/last historical gas usage.

The application change rate refers to the highest calculated possible change rate for the industrial user.

In some embodiments, if an application estimated usage by the industrial user is lower than the gas usage corresponding to the application change rate, then the gas usage delivered to the user may be the application estimated usage; if the application estimated usage by the industrial user is not lower than the gas usage corresponding to the application change rate, the gas usage delivered to the user may be the gas usage corresponding to the application change rate.

In some embodiments, the change rate of the industrial user may be calculated based on the change rate of other industrial users in the industrial user chain in which the industrial user is located. The mode of calculating the change rate may include, but not limited to, an interpolation method and a gradient conduction method, etc.

After calculating the change rate for the industrial user on the at least one industrial user chain, the application change rate for the industrial user may be calculated by combining the change rate with the gas association value with the upstream industrial user. A calculation mode for the application change rate may be expressed as: application change rate=sum {interpolation result (i.e., change rate) for one industrial user chain*gas association value}.

For example, the difference method may be used for the calculation: assuming the change rates on industrial user chain 1 is +2%, +4%, x, +8% in order, and the change rates on industrial user chain 2 is +3%, +6%, x, +12% in order, where x indicates an unknown change rate of the industrial user corresponding to the node. By using the interpolation method, the change rate x may be +6% on the industrial user chain 1 and +9% on the industrial user chain 2. Meanwhile, if the gas association value between the industrial user corresponding to +4% and the industrial user corresponding to x is 0.3, and the gas association value between the industrial user corresponding to +6% and the industrial user corresponding to x is 0.7, then the application change rate x may be +8.1% (0.3*(+6%)+0.7*(+9%)=(+1.8%)+(+6.3%)). That is, the user may increase the usage by up to 8.1% based on a usual level.

In some embodiments, after determining the application change rate for an individual industrial user, a variation in the gas usage for the individual industrial users may also be determined, thereby determining the usage trend for each individual industrial user. Based on the usage trend for each individual industrial user, an estimated usage trend vector may be constructed, and the estimated usage trend vector may be determined as the usage trend distribution.

By representing the data of a plurality of industrial users using the user association mapping, while the feature data of the industrial user may be better reflected, the relationship and interaction between the industrial users may be better illustrated as well. This allows for a better determination of the usage trend distribution and thus improves the accuracy of the gas regulation.

In some embodiments of the present disclosure, a computer-readable storage medium may be provided. The storage medium may store computer instructions, and when the computer reads the computer instructions from the storage medium, the computer executes the industrial gas demand regulation method based on smart gas.

The basic concepts have been described above, and it is apparent to those skilled in the art that the foregoing detailed disclosure is intended as an example only and does not constitute a limitation of the present disclosure. While not expressly stated herein, various modifications, improvements, and amendments may be made to the present disclosure by those skilled in the art. These types of modifications, improvements, and amendments are suggested in the present disclosure, so these types of modifications, improvements, and amendments remain within the spirit and scope of the exemplary embodiments of the present disclosure.

Finally, it should be understood that the embodiments described in the present disclosure are used only to illustrate the principles of the embodiments of the present disclosure. Other deformations may also fall within the scope of the present disclosure. Therefore, as an example, not as a limitation, alternative configurations of the embodiments of the present disclosure may be viewed as being consistent with the teachings of the present disclosure. Correspondingly, the embodiments of the present disclosure are not limited to the embodiments expressly presented and described herein.

What is claimed is:

1. A method for an industrial gas demand regulation based on a smart gas, wherein the method is executed based on a smart gas management platform of an Internet of things (IoT) system for an industrial gas demand regulation based on a smart gas, the method comprising:
obtaining gas data and a user feature of at least one industrial user, the gas data including gas operation data and gas demand data of the at least one industrial user;
determining, based on the gas data, the user feature, and an external feature, an estimated usage distribution;
sending the estimated usage distribution to a smart gas user platform to obtain feedback data from the at least one industrial user;
determining, based on the feedback data and the estimated usage distribution, an updated usage distribution; and
determining a gas regulation program based on the updated usage distribution, the gas regulation program comprising at least one of a gas transmission volume or a gas storage volume between regions where the at least one industrial user is located.

2. The method of claim 1, wherein the determining, based on the gas data, the user feature, and an external feature, an estimated usage distribution comprises:
for any one of the at least one industrial user,
determining, based on the user feature, historical use data, use plan demand, and the external feature of the industrial user, a demand authenticity of the industrial user, the gas demand data including the use plan demand;
determining, based on the use plan demand and the demand authenticity, an estimated usage of the industrial user; and
determining, based on the estimated usage corresponding to the at least one industrial user, the estimated usage distribution.

3. The method according to claim 2, wherein the determining, based on the user feature, historical use data, use plan demand, and the external feature of the industrial user, a demand authenticity of the industrial user comprises:
predicting, based on the user feature, the historical use data, the use plan demand, and the external feature, the demand authenticity by means of an authenticity prediction model, wherein the authenticity prediction model is a machine learning model.

4. The method of claim 3, wherein an input of the authenticity prediction model further includes a usage trend distribution and a user number corresponding to at least one industrial user chain, wherein the at least one industrial user chain is a user chain to which the industrial users belong.

5. The method of claim 3, wherein the authenticity prediction model includes a plurality of authenticity prediction sub-models;
the predicting, based on the user feature, the historical use data, the use plan demand, and the external feature, the demand authenticity by means of an authenticity prediction model comprises:
predicting, based on the user feature, the historical use data, the use plan demand, and the external feature, a sub-demand authenticity of the industrial user by the authenticity prediction sub-model; and
determining, based on a plurality of the sub-demand authenticities, the demand authenticity by weighting, wherein the weighting of the sub-demand authenticities is related to a distance of the sub-requirement authenticity from an average of a plurality of the sub-requirement authenticities and a demand fluctuation.

6. The method of claim 2, wherein the method further comprises:
determining, based on the user feature, at least one historical use data and at least one use plan demand of the at least one industrial user, at least one usage trend distribution, the at least one usage trend distribution including a usage trend distribution of industrial users of the same type and a usage trend distribution of upstream and downstream industrial users; and
determining, based on the at least one usage trend distribution, the demand authenticity of the at least one industrial user.

7. The method of claim 6, wherein the determining, based on the user feature, at least one historical use data and at least one use plan demand of the at least one industrial user, at least one usage trend distribution comprises:
constructing a user association mapping based on the user features of the at least one industrial user, the at least one historical use data, and the at least one use plan demand;
determining, based on the user association mapping, at least one industrial user chain; and
determining, based on the at least one industrial user chain, the at least one usage trend distribution.

8. The method of claim 1, wherein the determining, based on the updated usage distribution, a gas regulation program comprises:
determining, based on the updated usage distribution, a gas demand class;
generating, based on the gas demand class, at least one candidate gas regulation program;
evaluating regulation effectiveness degree of the at least one candidate gas regulation program; and
determining, based on the regulation effectiveness degree, the gas regulation program.

9. The method of claim 8, wherein the determining, based on the updated usage distribution, a gas demand class comprises:
determining, based on the updated usage distribution, a gas demand distribution; and
determining, based on the gas demand distribution, the gas demand class.

10. The method of claim 8, wherein the evaluating regulation effectiveness degree of the at least one candidate gas regulation program comprises:
evaluating, based on a preset strategy, regulation effectiveness degree of the at least one candidate gas regulation program, the preset strategy being related to a relationship between a total dispatch volume and a current pipeline supply volume, a change in a pipeline pressure, and a dispatch efficiency.

11. An Internet of things (IoT) system for an industrial gas demand regulation based on a smart gas, wherein the system includes a smart gas user platform, a smart gas service platform, a smart gas management platform, a smart gas sensor network platform, and a smart gas object platform;
the smart gas management platform includes a gas business management sub-platform, a non-gas business management sub-platform and a smart gas data center;
the smart gas sensor network platform is configured to interact with the smart gas data center and the smart gas object platform;
the smart gas object platform is configured to obtain gas data; and
the smart gas management platform is configured to:
obtain gas data and a user feature of at least one industrial user, the gas data including gas operation data and gas demand data of the at least one industrial user;
determine, based on the gas data, the user feature, and an external feature, an estimated usage distribution;
send the estimated usage distribution to a smart gas user platform to obtain feedback data from the at least one industrial user;
determine, based on the feedback data and the estimated usage distribution, an updated usage distribution; and
determine, based on the updated usage distribution, a gas regulation program, the gas regulation program including at least one of a gas transmission volume and a gas storage volume between a region where the at least one industrial user is located.

12. The system of claim 11, wherein the smart gas management platform is further configured to:
for any one of the at least one industrial user,
determine, based on the user feature, historical use data, use plan demand, and the external feature of the industrial user, a demand authenticity of the industrial user, the gas demand data including the use plan demand;
determine, based on the use plan demand and the demand authenticity, an estimated usage of the industrial user; and
determine, based on the estimated usage corresponding to the at least one industrial user, the estimated usage distribution.

13. The system of claim 12, wherein the smart gas management platform is further configured to:
predict, based on the user feature, the historical use data, the use plan demand, and the external feature, the demand authenticity by means of an authenticity prediction model, wherein the authenticity prediction model is a machine learning model.

14. The system of claim 13, wherein the authenticity prediction model includes a plurality of authenticity prediction sub-models; the smart gas management platform is further configured to:
predict, based on the user feature, the historical use data, the use plan demand, and the external feature, a sub-demand authenticity of the industrial user by the authenticity prediction sub-model; and
determine, based on a plurality of the sub-demand authenticities, the demand authenticity by weighting, wherein the weighting of the sub-demand authenticities is related to a distance of the sub-requirement authenticity from an average of a plurality of the sub-requirement authenticities and a demand fluctuation.

15. The system of claim 12, wherein the smart gas management platform is further configured to:
determine, based on the user feature, at least one historical use data and at least one use plan demand of the at least one industrial user, at least one usage trend distribution, the at least one usage trend distribution including a usage trend distribution of industrial users of the same type and a usage trend distribution of upstream and downstream industrial users; and
determine, based on the at least one usage trend distribution, the demand authenticity of the at least one industrial user.

16. The system of claim 15, wherein the smart gas management platform is further configured to:
construct, based on the user feature of the at least one industrial user, at least one historical use data and at least one use plan demand, a user association mapping;
determine at least one industrial user chain based on the user association mapping; and
determine the at least one usage trend distribution based on the at least one industrial user chain.

17. The system of claim 11, wherein the smart gas management platform is further configured to:
determine, based on the updated usage distribution, a gas demand class;
generate, based on the gas demand class, at least one candidate gas regulation program;
evaluate regulation effectiveness degree of the at least one candidate gas regulation program; and
determine, based on the regulation effectiveness degree, the gas regulation program.

18. The system of claim 17, wherein the smart gas management platform is further configured to:
determine, based on the updated usage distribution, a gas demand distribution; and
determine, based on the gas demand distribution, the gas demand class.

19. The system of claim 17, wherein the smart gas management platform is further configured to:
evaluate, based on a preset strategy, the regulation effectiveness degree of the at least one candidate gas regulation program, the preset strategy being related to a relationship between a total dispatch volume and a current pipeline supply volume, a change in a pipeline pressure, and a dispatch efficiency.

20. A non-transitory computer-readable storage medium storing computer instructions, wherein when reading the computer instructions in the storage medium, a computer implements the method of claim 1.
